(19) United States
(12) Patent Application Publication
(10) Pub. No.: US 2024/0428992 A1
(43) Pub. Date: Dec. 26, 2024

(54) MULTILAYER CERAMIC CAPACITOR

(71) Applicant: Murata Manufacturing Co., Ltd., Nagaokakyo-shi (JP)

(72) Inventors: Kenji KIMURA, Nagaokakyo-shi (JP); Kosuke URATANI, Nagaokakyo-shi (JP); Takehisa SASABAYASHI, Nagaokakyo-shi (JP)

(21) Appl. No.: 18/818,712

(22) Filed: Aug. 29, 2024

Related U.S. Application Data
(63) Continuation of application No. PCT/JP2023/016390, filed on Apr. 26, 2023.

(30) Foreign Application Priority Data
May 12, 2022 (JP) 2022-079053

(51) Int. Cl. H01G 4/012; H01G 4/008; H01G 4/232; H01G 4/30

(52) U.S. Cl. CPC H01G 4/012; H01G 4/008; H01G 4/2325; H01G 4/30

(57) ABSTRACT

A multilayer ceramic capacitor includes a multilayer body including an inner layer portion defined by alternately laminating a plurality of dielectric layers and a plurality of inner electrode layers, and a pair of side margin portions sandwiching the inner layer portion in a width direction. When viewing a cross-section provided by cutting the multilayer body at a position at a central portion in a length direction and defined by the width direction and a lamination direction, a crystalline oxide including at least one of Al, Mg, and Si is present in the side margin portions as an elongate secondary phase at an aspect ratio equal to or above about 5 and equal to or below about 20.

### CROSS REFERENCE TO RELATED APPLICATIONS

This application is a Continuation Application of PCT Application No. PCT/JP2023/016390, filed on Apr. 26, 2023, and claims the benefit of priority to Japanese Patent Application No. 2022-079053, filed on May 12, 2022. The entire contents of each application are hereby incorporated herein by reference.

### BACKGROUND OF THE INVENTION

### 1. Field of the Invention

The present invention relates to multilayer ceramic capacitors.

### 2. Description of the Related Art

In general, a multilayer ceramic capacitor includes a multilayer body in which dielectric layers and inner electrode layers are alternately laminated and dielectric layers are further laminated at an upper surface and a lower surface thereof, and a pair of outer electrodes formed at both end surfaces of the multilayer body. In order to relatively increase the area of the inner electrode layers, there is a multilayer body which adopts a structure including an inner layer portion formed by laminating the dielectric layers and the inner electrode layers and provided with an electrostatic capacitance, and side margin portions formed by disposing dielectric layers on both sides of the inner layer portion (see Japanese Unexamined Patent Application Publication No. 10-50545, for example). Moreover, regarding the above-described multilayer ceramic capacitor, it is important to secure a large area for the inner electrode layers by reducing thicknesses of the side margin portions in the width direction and enlarging the inner layer portion in order to deal with downsizing and multiple functions of electronic products in recent years and to achieve a further decrease in size and a further increase in capacitance.

However, when firing the multilayer body having the structure including the side margin portions, gaps are prone to develop between the inner layer portion and the side margin portions, or especially between end portions on both sizes of the inner electrode layers and the right and left side margin portions due to a difference in percentage of shrinkage. Then, insulation resistance between the dielectric layers is deteriorated by intrusion of moisture into the aforementioned gaps and functions as the multilayer ceramic capacitor are degraded. The aforementioned problems become increasingly serious as the thicknesses in a width direction of the side margin portions are reduced more, thus losing reliability of the multilayer ceramic capacitor.

Accordingly, there has been a demand for developing a multilayer ceramic capacitor provided with high reliability while being small in size and large in capacitance.

### SUMMARY OF THE INVENTION

Example embodiments of the present invention provide multilayer ceramic capacitors, each of which reduces or prevents the occurrence of a gap developed between an inner layer portion and a side margin portion, and has high reliability while being small in size and large in capacitance.

As a consequence of studies conducted by the inventors of example embodiments of the present invention to solve the aforementioned problems, the inventors have discovered that reliability in terms of moisture resistance and withstand voltage can be maintained while achieving a small size and a large capacitance when a crystalline oxide including at least one of Al, Mg, and Si is segregated as a secondary phase with a prescribed cross-sectional shape at side margin portions defining a multilayer body, and have thus accomplished the present invention.

An example embodiment of the present invention provides a multilayer ceramic capacitor, which includes a multilayer body including an inner layer portion defined by alternately laminating a plurality of dielectric layers and a plurality of inner electrode layers, a pair of outer layer portions sandwiching the inner layer portion in a lamination direction, and a pair of side margin portions sandwiching the inner layer portion and the outer layer portions in a width direction being orthogonal to the lamination direction, and a pair of outer electrodes at both ends of the multilayer body in a length direction orthogonal or substantially orthogonal to the lamination direction and the width direction, the outer electrodes including a first outer electrode and a second outer electrode electrically connected to a first inner electrode layer and a second inner electrode layer of the inner electrode layers, respectively. When viewing a cross-section defined by cutting the multilayer body at a position at a central portion in the length direction and defined by the width direction and the lamination direction, a crystalline oxide including at least one of Al, Mg, and Si is provided in the side margin portions as an elongate secondary phase at an aspect ratio equal to or above about 5 and equal to or below about 20.

According to example embodiments of the present invention, it is possible to provide multilayer ceramic capacitors, each of which can reduce or prevent the occurrence of a gap between an inner layer portion and a side margin portion, and has excellent moisture resistance as well as withstand voltage and provided with high reliability while being small in size and large in capacitance.

The above and other elements, features, steps, characteristics and advantages of the present invention will become more apparent from the following detailed description of the example embodiments with reference to the attached drawings.

### BRIEF DESCRIPTION OF THE DRAWINGS

FIG. 1 is a perspective view schematically illustrating an example embodiment of a multilayer ceramic capacitor of the present invention.

FIG. 2 is a perspective view schematically illustrating an example embodiment of a multilayer body defining the multilayer ceramic capacitor illustrated in FIG. 1.

FIG. 3 is a cross-sectional view taken along the A-A line of the multilayer ceramic capacitor illustrated in FIG. 1.

FIG. 4 is a cross-sectional view taken along the C-C line of the multilayer ceramic capacitor illustrated in FIG. 1.

FIG. 5 is a cross-sectional view taken along the B-B line of the multilayer ceramic capacitor illustrated in FIG. 1.

FIG. 6 is a plan view schematically illustrating an example embodiment of a ceramic green sheet of the present invention.

FIG. 7 is a plan view schematically illustrating an

example embodiment of another ceramic green sheet of the present invention.

FIG. 8 is a plan view schematically illustrating an

example embodiment of another ceramic green sheet of the present invention.

FIG. 9 is an exploded perspective view schematically

illustrating an example embodiment of a mother block of the present invention.

FIG. 10 is a perspective view schematically illustrating

an example embodiment of a green chip of the present invention.

FIG. 11 is a diagram (a drawing-substituting photograph)

depicting a distribution state of Al on a cross-section taken along the C-C line.

FIG. 12 is a diagram (a drawing-substituting photograph) depicting a distribution state of Mg on the cross-section taken along the C-C line.

FIG. 13 is a diagram (a drawing-substituting photograph) depicting a distribution state of Si on the cross-section taken along the C-C line.

### DETAILED DESCRIPTION OF THE EXAMPLE EMBODIMENTS

Multilayer ceramic capacitors according to example embodiments of the present invention will be described below with reference to the drawings. The present invention is not limited to the following example embodiments, and can be applied in an appropriately modified manner within the range not departing from the scope of the present invention.

### Multilayer Ceramic Capacitor

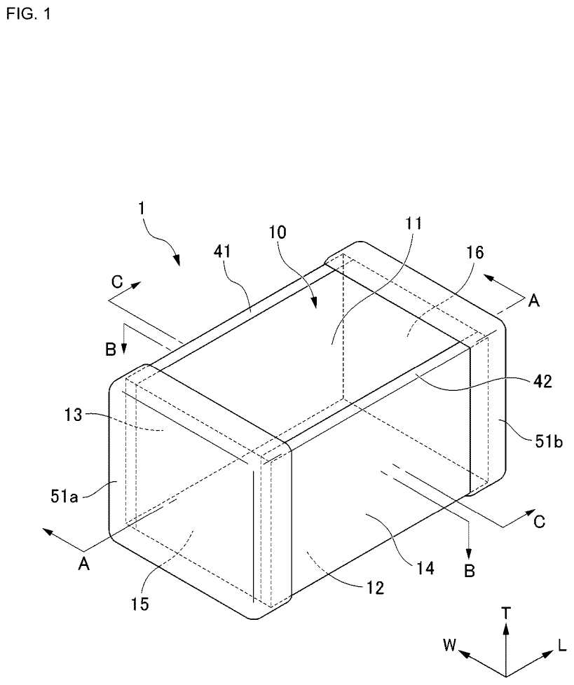

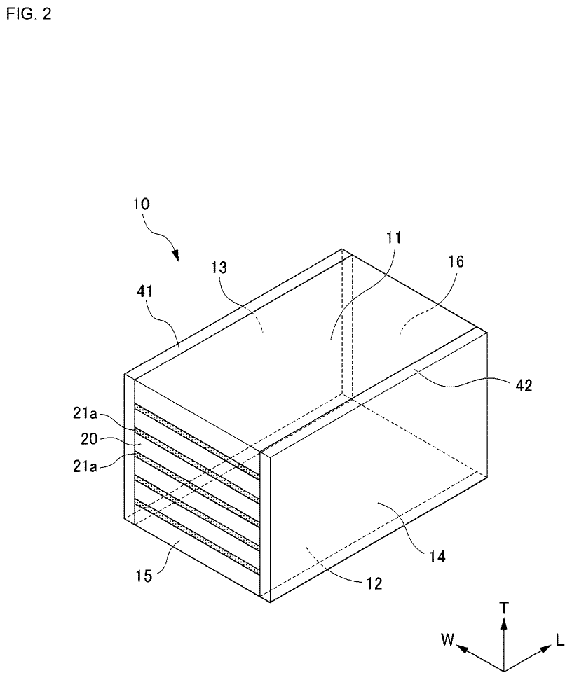

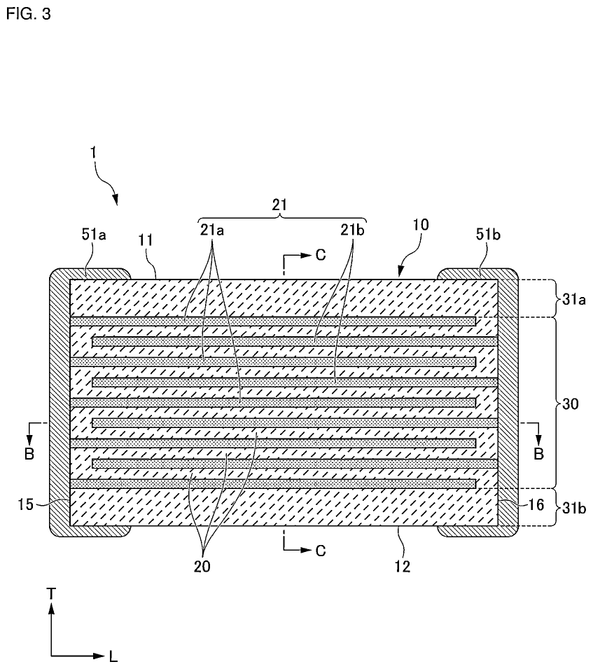

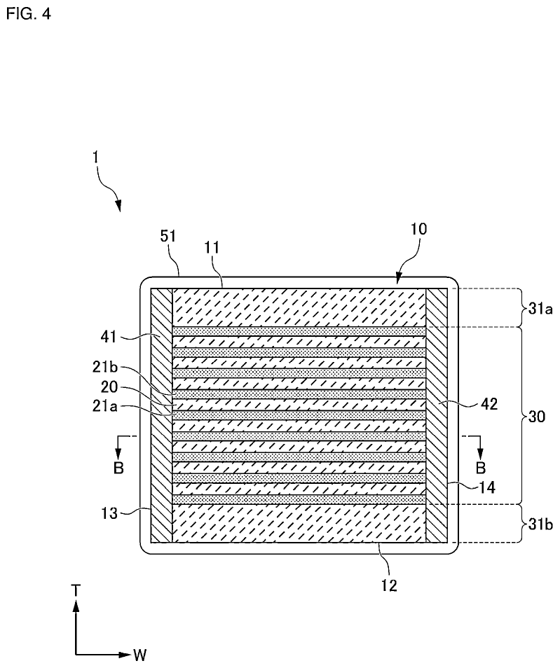

FIG. 1 is a perspective view schematically illustrating an example of a multilayer ceramic capacitor of the present invention. FIG. 2 is a perspective view schematically illustrating an example of a multilayer body included in the multilayer ceramic capacitor illustrated in FIG. 1. FIG. 3 is a cross-sectional view taken along the A-A line of the multilayer ceramic capacitor illustrated in FIG. 1. FIG. 4 is a cross-sectional view taken along the C-C line of the multilayer ceramic capacitor illustrated in FIG. 1.

In the present specification, a lamination direction, a width direction, and a length direction of a multilayer ceramic capacitor and a multilayer body will be defined as directions indicated with arrows T, W, and L, respectively, in view of a multilayer ceramic capacitor 1 illustrated in FIG. 1 and a multilayer body 10 illustrated in FIG. 2. In an example embodiment of the present invention, the lamination (T) direction, the width (W) direction, and the length (L) direction are orthogonal or substantially orthogonal to one another. However, the directions do not always have to satisfy the mutually orthogonal or substantially orthogonal relationships but may satisfy mutually intersecting relationships instead. The lamination (T) direction is a direction to stack multiple dielectric layers 20 and multiple pairs of first inner electrode layers 21a and second inner electrode layers 21b.

The multilayer ceramic capacitor 1 illustrated in FIG. 1 includes the multilayer body 10, and a pair of outer electrodes including a first outer electrode 51a and a second outer electrode 51b, which are provided on both end surfaces of the multilayer body 10.

As illustrated in FIG. 2, the multilayer body 10 has a cuboid shape or a substantially cuboid shape, and includes a first principal surface 11 and a second principal surface 12 which are opposed to each other in the lamination (T) direction, a first side surface 13 and a second side surface 14 which are opposed to each other in the width (W) direction being orthogonal or substantially orthogonal to the lamination (T) direction, and a first end surface 15 and a second end surface 16 which are opposed to each other in the length (L) direction being orthogonal or substantially orthogonal to the lamination (T) direction and the width (W) direction.

In the present specification, a cross-section of the multilayer ceramic capacitor 1 or the multilayer body 10 being orthogonal or substantially orthogonal to the first end surface 15 and the second end surface 16 and being parallel or substantially parallel to the lamination (T) direction will be referred to as an LT cross-section representing a cross-section in the length (L) direction and the lamination (T) direction. Meanwhile, a cross-section of the multilayer ceramic capacitor 1 or the multilayer body 10 being orthogonal or substantially orthogonal to the first side surface 13 and the second side surface 14 and being parallel or substantially parallel to the lamination (T) direction will be referred to as a WT cross-section representing a cross-section in the width (W) direction and the lamination (T) direction. In the meantime, a cross-section of the multilayer ceramic capacitor 1 or the multilayer body 10 being orthogonal or substantially orthogonal to the first side surface 13 and the second side surface 14 as well as the first end surface 15 and the second end surface 16 and being orthogonal or substantially orthogonal to the lamination (T) direction will be referred to as an LW cross-section representing a cross-section in the length (L) direction and the width (W) direction. Therefore, FIG. 3 represents the LT cross-section of the multilayer ceramic capacitor 1 while FIG. 4 represents the WT cross-section of the multilayer ceramic capacitor 1.

Corner portions and ridge portions of the multilayer body 10 are preferably rounded. A corner portion is a portion where three surfaces of the multilayer body cross one another, and a ridge portion is a portion where two surfaces of the multilayer body cross each other.

As illustrated in FIGS. 2, 3, and 4, the multilayer body 10 has a multilayer structure obtained by laminating the multiple dielectric layers 20 and multiple inner electrode layers 21 in the lamination (T) direction.

The inner electrode layers 21 include the first inner electrode layers 21a and the second inner electrode layers 21b, and each dielectric layer 20 is located between the first inner electrode layer 21a and the second inner electrode layer 21b.

The dielectric layers 20 extend along the width (W) direction and the length (L) direction, and each of the first inner electrode layers 21a and the second inner electrode layers 21b extends in a flat plate fashion along the dielectric layers 20.

In order to render the multilayer ceramic capacitor small in size and large in capacitance, it is necessary to laminate as many inner electrode layers and dielectric layers as possible within a predetermined range of height. Accordingly, a thickness in the lamination (T) direction of each dielectric layer 20 sandwiched between the inner electrode layers 21a and 21b is, for example, preferably set equal to or below about 0.45 μm and external dimensions of the multilayer body are preferably set to a length equal to or below about 1.0 mm, a width equal to or below about 0.5 mm, and a height equal to or below about 0.5 mm.

The first inner electrode layers 21a extend to the first end surface 15 of the multilayer body 10. On the other hand, the second inner electrode layers 21b extend to the second end surface 16 of the multilayer body 10.

The first inner electrode layers 21a and the second inner electrode layers 21b are each opposed to each other in the lamination (T) direction with the dielectric layer 20 interposed therebetween. An electrostatic capacitance is generated by the portion where the first inner electrode layer 21a is opposed to the second inner electrode layer 21b with the dielectric layer 20 interposed therebetween.

Each of the first inner electrode layers 21a and the second inner electrode layers 21b preferably includes a metal such as, for example, Ni, Cu, Ag, Pd, Ag—Pd alloy, and Au. In addition to the metals mentioned above, each of the first inner electrode layers 21a and the second inner electrode layers 21b may include the same dielectric ceramic material as the dielectric layers 20.

The first outer electrode 51a is provided at the first end surface 15 of the multilayer body 10, and includes portions that wrap around respective portions of the first principal surface 11, the second principal surface 12, the first side surface 13, and the second side surface 14 in FIG. 1. The first outer electrode 51a is coupled to the first inner electrode layers 21a at the first end surface 15.

The second outer electrode 51b is provided at the second end surface 16 of the multilayer body 10, and includes portions that wrap around respective portions of the first principal surface 11, the second principal surface 12, the first side surface 13, and the second side surface 14 in FIG. 1. The second outer electrode 51b is coupled to the second inner electrode layers 21b at the second end surface 16.

The first outer electrode 51a and the second outer electrode 51b can each include a foundation electrode layer and a plated layer on the foundation electrode layer, for example. The foundation electrode layer is provided by applying a conductive paste that includes a metal component and a glass component onto the end surfaces 15 and 16 of the multilayer body 10, and then baking the conductive paste. The metal component to be blended into the conductive paste can adopt a metal such as, for example, Cu, Ni, Ag, Pd, and Au, an alloy of Ag and Pd, and the like.

The plated layer to be provided on the foundation electrode layer preferably includes at least one of the metals such as, for example, Cu, Ni, Ag, Pd, and Au, the alloy of Ag and Pd, and the like. The plated layer may have a double-layered structure of a Ni-plated layer and a Sn-plated layer, for example. Nonetheless, the plated layer may include a single layer or include multiple layers.

As illustrated in FIGS. 2, 3, and 4, the multilayer body 10 includes an inner layer portion 30 in which the dielectric layers 20, the first inner electrode layers 21a, and the second inner electrode layers 21b are laminated, a pair of outer layer portions 31a and 31b arranged in such a way as to sandwich the inner layer portion 30 in the lamination (T) direction, and a pair of side margin portions 41 and 42 disposed in such a way as to sandwich the inner layer portion 30, the outer layer portion 31a, and the outer layer portion 31b in the width (W) direction.

In FIGS. 3 and 4, the inner layer portion 30 is a region sandwiched between the first inner electrode layer 21a located closest to the first principal surface 11 and the first inner electrode layer 21a located closest to the second principal surface 12 along the lamination (T) direction. The outer layer portion 31a and the outer layer portion 31b can be provided as a common structure to the dielectric layers 20, and can be made of the same dielectric ceramic material as the dielectric layers 20.

A thickness of each of the outer layer portions 31a and 31b is, for example, preferably equal to or above about 15 μm and equal to or below about 40 μm. Here, each of the outer layer portions 31a and 31b may have a single-layer structure instead of a multilayer structure.

As illustrated in FIG. 4, the side margin portions 41 and 42 each include a single dielectric layer, but may instead include multiple dielectric layers laminated in the width (W) direction.

The dielectric layers 20 and the side margin portions 41 and 42 are made of a dielectric ceramic material including BaTiO₃ and the like as a major component, for example. The major component defines a main phase. The dielectric layers 20 of the inner layer portion 30 may further include a sintering aid element. It is to be noted, however, that preferred compositions of the dielectric ceramic materials used for the dielectric layers and the side margin portions can be selected, respectively, depending on purposes of disposition or characteristics required in light of manufacturing methods.

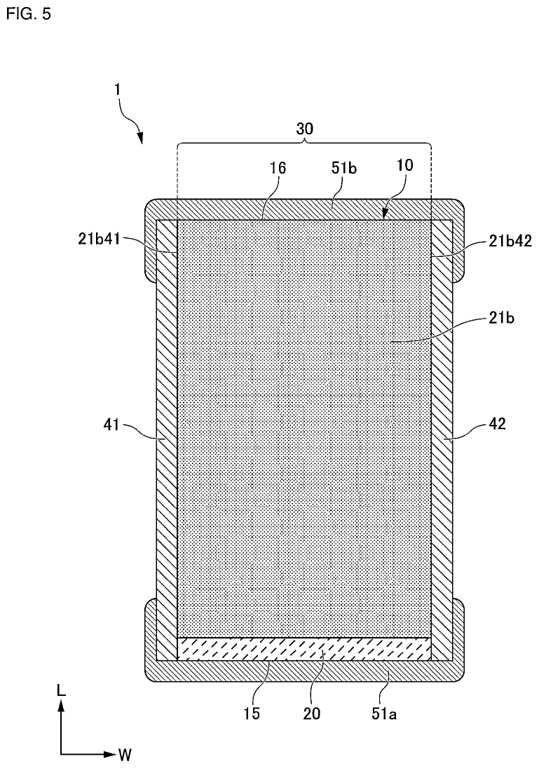

FIG. 5 is a cross-sectional view taken along the B-B line of the multilayer ceramic capacitor illustrated in FIG. 1.

FIG. 5 illustrates the LW cross-section of the multilayer ceramic capacitor 1.

As illustrated in FIG. 5, the second inner electrode layer 21b is exposed to the second end surface 16 of the multilayer body 10. Meanwhile, the side margin portions 41 and 42 are disposed on the first side surface 13 side and the second side surface 14 side of the multilayer body 10, respectively. As illustrated in FIG. 5, interfaces 21b41 and 21b42 are present between both side end portions of the second inner electrode layer 21b and the left and right side margin portions 41 and 42.

### Crystalline Oxide

The multilayer body was cut at a position (the C-C line) at a central portion in the length (L) direction, and the WT cross-section in a range of, for example, about 10 μm×about 10 μm defined in the width (W) direction and the lamination (T) direction was observed by using wavelength-dispersive X-ray spectroscopy (WDX). As a result, it was confirmed that a crystalline oxide including, for example, at least one of Al, Mg, and Si was present in the side margin portions as a secondary phase of an elongate cross-section at an aspect ratio equal to or above about 5 and equal to or below about 20. Here, the aspect ratio was calculated as a ratio of a major axis length to an averaged minor axis length in a case of approximating the shape of the secondary phase observed on the cross-section by an ellipse having the same area. In calculating the averaged minor axis length and the averaged major axis length, each average was weighted by the area of the approximated ellipse.

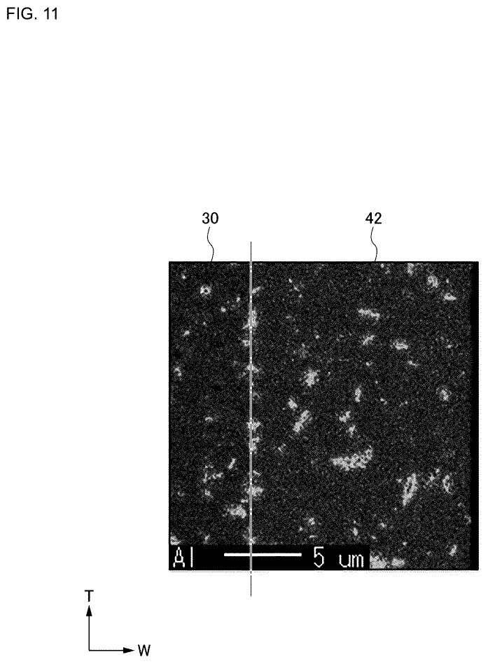

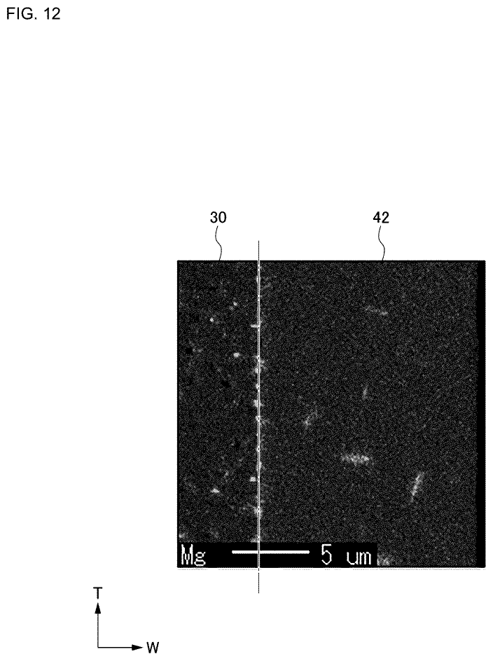

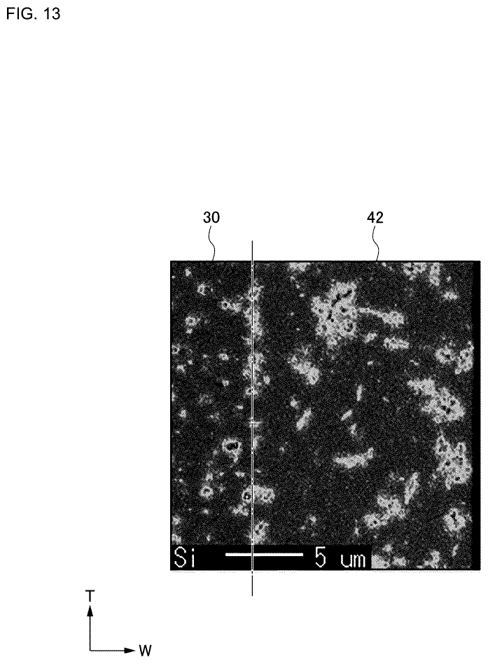

FIG. 11 is an image depicting a distribution state of Al (element) in the inner layer portions and the side margin portions on the cross-section taken along the C-C line, which was taken in accordance with the wavelength-dispersive X-ray spectroscopy (WDX). Likewise, FIG. 12 is an image depicting a distribution state of Mg (element). Likewise, FIG. 13 is an image depicting a distribution state of Si (element).

Regarding the multilayer body having the structure to include the side margin portions, it is possible to reduce a difference in percentage of shrinkage between the inner layer portion and the side margin portions by blending a metal or a metal compound including, for example, at least one of Al, Mg, and Si with the side margin portions and then firing the multilayered body, so that the occurrence of a gap can be suppressed between the inner layer portion and the side margin portions, or in particular, between the both side end portions of the inner electrode layers and the left and right side margin portions. This makes: possible to prevent deterioration in insulation resistance that may be caused by intrusion of moisture into the gap, and to improve moisture resistance and withstand voltage. Meanwhile, after the firing, the crystalline oxide including, for example, at least one of Al, Mg, and Si is distributed to the side margin portions as the elongate secondary phase at the aspect ratio equal to or above 5 and equal to or below 20 on the cross-section taken along the C-C line, thereby maintaining the moisture resistance and the withstand voltage, and also exhibiting excellent effects in mechanical or thermal impact resistance.

The above-described advantageous effects are brought about by the presence of the crystalline oxide including at least one of Al, Mg, and Si in the side margin portions. Here, the crystalline oxide that includes, for example, two of or all the three of Al, Mg, and Si can further improve the advantageous effects. Accordingly, for example, it is preferable that about 90 atm % or more of Mg included in the crystalline oxide be made of a composite oxide including Al, Mg, and Si, or that 90 atm % or more of Al included in the crystalline oxide be made of a composite oxide including Al, Mg, and Si and a composite oxide including Al and Si.

### Evaluation Tests

One hundred samples of the multilayer ceramic capacitors including the side margin portions including the crystalline oxide of Al were prepared for respective prescribed aspect ratios of the secondary phase, and were subjected to evaluation tests for moisture resistance reliability and withstand voltage reliability.

The moisture resistance reliability test was performed at about 45° C. and about 95% RH under a voltage at about 10 V/μm while maintaining a state of application of a direct-current voltage for about 500 hours. A sample with insulation resistance reduced by one digit from that at a start of application of voltage resistance was determined to be disqualified, and the number of such samples were listed on Table 1.

The insulation resistance deterioration test was carried out while retaining a state of application at about 2.5 W for about 1000 hours. A sample with an insulation resistance value reduced by one digit was determined to be disqualified, and the number of such samples were listed on Table 1.

In the evaluation tests of the moisture resistance reliability and the withstand voltage reliability, the samples having the aspect ratio which did not cause any disqualified products were evaluated as qualified (A), and the samples having the aspect ratio which caused any disqualified products were evaluated as disqualified (B). Results of overall evaluations are indicated on Table 1.

TABLE 1

| | | Moisture | Withstand | |
|---|---|---|---|---|
| | Aspect | resistance | voltage | Overall |
| | ratio | reliability | reliability | evaluation |
| Comparative | 1.1 | 14/100 | 0/100 | B |
| Example 1 | | | | |
| Comparative | 2.3 | 6/100 | 0/100 | B |
| Example 2 | | | | |
| Comparative | 4.2 | 2/100 | 0/100 | B |
| Example 3 | | | | |
| Example 1 | 5.1 | 0/100 | 0/100 | A |
| Example 2 | 8.2 | 0/100 | 0/100 | A |
| Example 3 | 12.4 | 0/100 | 0/100 | A |
| Example 4 | 17.2 | 0/100 | 0/100 | A |
| Comparative | 20.3 | 0/100 | 2/100 | B |
| Example 4 | | | | |
| Comparative | 24.1 | 0/100 | 15/100 | B |
| Example 5 | | | | |

### Method of Manufacturing Multilayer Ceramic Capacitor

An example embodiment of a method of manufacturing the multilayer ceramic capacitor 1 illustrated in FIG. 1 will be described below.

Ceramic green sheets to be formed into the dielectric layers 20, the outer layer portions 31a and 31b, and the side margin portions 41 and 42 are prepared. In addition to ceramic raw materials including the dielectric ceramic materials, the ceramic green sheets include binder, solvents, and the like. Meanwhile, additive agents including rare earths may be added to the ceramic raw materials. It is possible to change compositions of dielectric bodies defining respective regions by changing elements to be included in the additive agents.

For example, each ceramic green sheet is preferably formed on a carrier film by using, for example, a die coater, a gravure coater, a micro gravure coater, and the like.

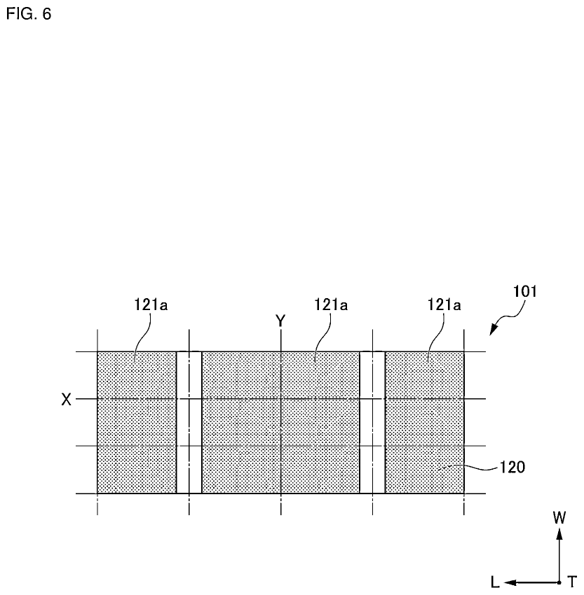

FIGS. 6, 7, and 8 are plan views schematically illustrating examples of the ceramic green sheets. FIGS. 6, 7, and 8 illustrate a first ceramic green sheet 101 for forming the inner layer portion 30, a second ceramic green sheet 102 for forming the inner layer portion 30, and a third ceramic green sheet 103 for forming the outer layer portion 31a or 31b, respectively.

Cutting lines X and Y for cutting the sheets into respective multilayer ceramic capacitors 1 are indicated on the first ceramic green sheet 101, second ceramic green sheet 102, and the third ceramic green sheet 103. The cutting lines X are parallel to the length (L) direction, and the cutting lines Y are parallel to the width (W) direction.

As illustrated in FIG. 6, in the first ceramic green sheet 101, unfired first inner electrode layers 121a corresponding to the first inner electrode layers 21a are formed on an unfired dielectric layer 120 corresponding to the dielectric layer 20.

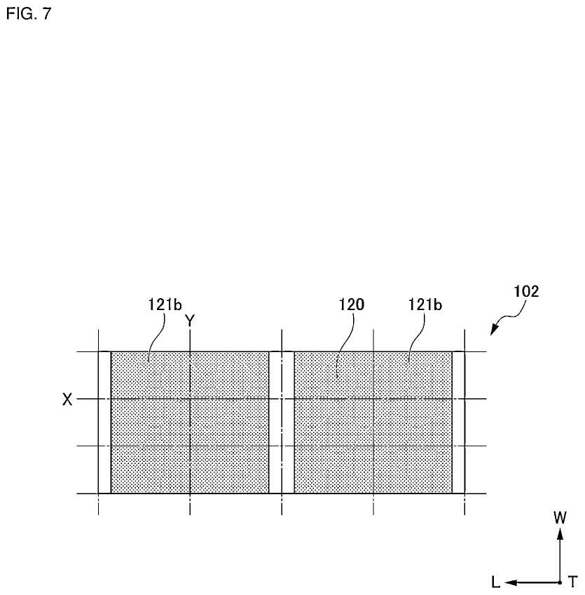

As illustrated in FIG. 7, in the second ceramic green sheet 102, unfired second inner electrode layers 121b corresponding to the second inner electrode layers 21b are formed on the unfired dielectric layer 120 corresponding to the dielectric layer 20.

Although a method of fabricating the first ceramic green sheet 101 illustrated in FIG. 6 and the second ceramic green sheet 102 illustrated in FIG. 7 is not limited to a particular method, there is a method of providing a surface of the unfired dielectric layer 120 with conductive paste that defines the inner electrode layer 21a or 21b each at a predetermined region by means of firing.

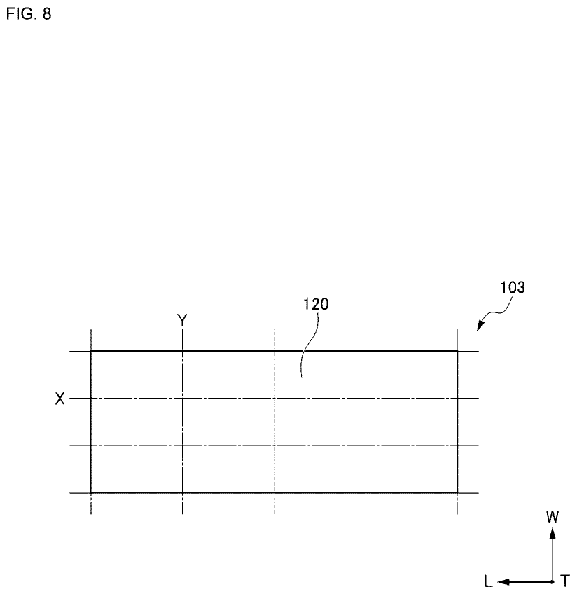

As illustrated in FIG. 8, the third ceramic green sheet 103 corresponding to the outer layer portion 31a or 31b can be formed by using the unfired dielectric layer 120 corresponding to the dielectric layer 20. No unfired inner electrode layer 121a or 121b is formed on the third ceramic green sheet 103 unlike the first ceramic green sheet 101 or the second ceramic green sheet 102.

The first inner electrode layers 121a and the second inner electrode layers 121b can be formed by using arbitrary conductive paste. A method such as, for example, a screen printing method and a gravure printing method can be used for formation of the first inner electrode layers 121a and the second inner electrode layers 121b by using the conductive paste.

The first inner electrode layers 121a and the second inner electrode layers 121b are provided across two regions being adjacent to each other in the length (L) direction and partitioned by the cutting line Y, and extend zonally in the width (W) direction. Regarding the first inner electrode layers 121a and the second inner electrode layers 121b, the regions partitioned by the cutting lines Y are displaced in the length (L) direction by one line at a time. That is to say, the cutting line Y passing through the center of the first inner electrode layer 121a passes through a region between the second inner electrode layers 121b located adjacent to each other, and the cutting line Y passing through the center of the second inner electrode layer 121b passes through a region between the first inner electrode layers 121a located adjacent to each other.

Thereafter, a mother block is fabricated by laminating the first ceramic green sheet 101, the second ceramic green sheet 102, and the third ceramic green sheet 103.

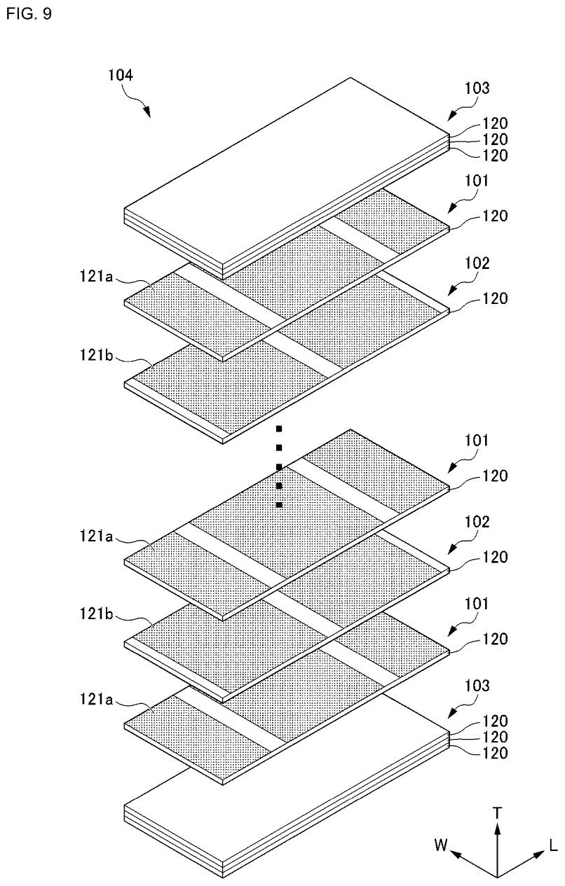

FIG. 9 is an exploded perspective view schematically illustrating an example of the mother block.

FIG. 9 illustrates the first ceramic green sheet 101, the second ceramic green sheet 102, and the third ceramic green sheet 103 in an exploded manner for explanatory convenience. In an actual mother block 104, however, the first ceramic green sheet 101, the second ceramic green sheet 102, and the third ceramic green sheet 103 are pressure bonded and integrated together by means of an isostatic press and the like.

In the mother block 104 illustrated in FIG. 9, the first ceramic green sheets 101 and the second ceramic green sheets 102 corresponding to the inner layer portion 30 are alternately laminated in the lamination (T) direction. Moreover, the third ceramic green sheets 103 corresponding to the outer layer portions 31a and 31b are laminated on upper and lower surfaces in the lamination (T) direction of the first ceramic green sheets 101 and the second ceramic green sheets 102 which are alternately laminated. Although three third ceramic green sheets 103 are laminated at each end in FIG. 9, the number of the third ceramic green sheets 103 can be changed as appropriate.

Multiple green chips are fabricated by cutting the mother block 104 thus obtained along the cutting lines X and Y (see FIGS. 6, 7, and 8). A method such as, for example, cutting with a dicing machine, push cutting, and laser cutting is applied in this cutting process.

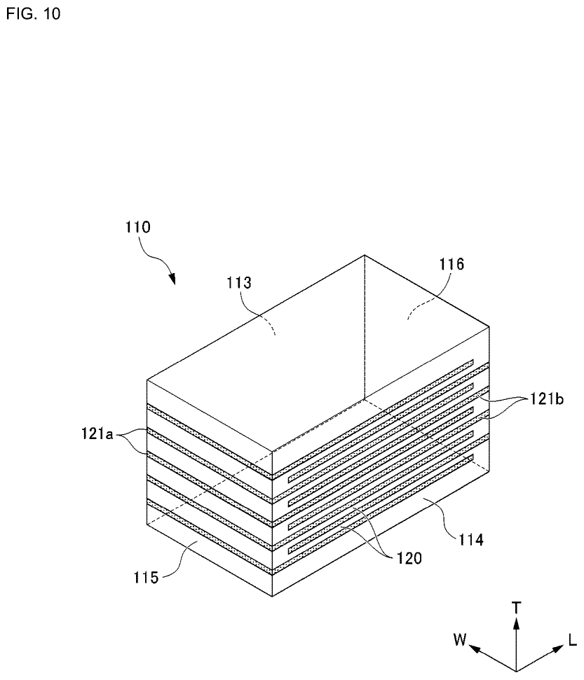

FIG. 10 is a perspective view schematically illustrating

an example of the green chip.

A green chip 110 illustrated in FIG. 10 has a laminated structure including the dielectric layers 120, the first inner electrode layers 121a, and the second inner electrode layers 121b which are in the unfired state. A first side surface 113 and a second side surface 114 of the green chip 110 are surfaces that are produced as a consequence of cutting along the cutting lines X, while a first end surface 115 and a second end surface 116 thereof are surfaces that are produced as a consequence of cutting along the cutting lines Y. The first inner electrode layers 121a and the second inner electrode layers 121b are exposed to the first side surface 113 and the second side surface 114. Meanwhile, the first inner electrode layers 121a are exposed to the first end surface 115 while the second inner electrode layers 121b are exposed to the second end surface 116.

Here, regarding the first side surface 113 and the second side surface 114 of the green chip 110, there is a case where the side surfaces are plastically deformed slightly downward due to a stress that is applied downward in the drawing being equivalent to a cutting direction when obtaining the green chips 110 by cutting the mother block 104. Meanwhile, there is also a case where such cutting surfaces are not sufficiently smooth or a case where foreign matters are present on the cutting surfaces. For this reason, it is preferable to polish the first side surface 113 and the second side surface 114 so as to remove deformed portions.

An unfired multilayer body is obtained by forming unfired side margin portions on the first side surface 113 and the second side surface 114 of the obtained green chip 110. The unfired side margin portions are formed, for example, by attaching ceramic green sheets made of dielectric ceramics to the first side surface and the second side surface of the green chip.

A ceramic slurry including binder, a solvent, and the like in addition to the ceramic raw material including the dielectric ceramic material including, for example, BaTiO₃ and the like as the major components is prepared in order to fabricate the ceramic green sheet for forming the side margin portions. At least one metallic element of Al, Mg, and Si, for example, to be segregated as the crystalline oxide at the side margin portions is added to the ceramic slurry. These components can be added as a metal or a compound such as a metal oxide, for example. In the meantime, in the case of adding two or more of these metallic elements, it is also possible to add these metallic elements in the form of an alloy or a composite compound such as a composite metal oxide.

For example, it is possible to prepare, weigh, and add Al₂O₃, MgO, and SiO₂, respectively. Here, Al₂O₃, MgO, and SiO₂ are weighed to satisfy a prescribed proportion and these weighed substances are put into a ball mill together with PSZ balls and purified water. After conducting sufficient wet type mixing and pulverization, a composite oxide is fabricated by a thermal treatment at about 900° C. Then, this composite oxide can also be added to the ceramic slurry. Here, MgO can be generated by thermal decomposition of MgCO₃. Accordingly, a predetermined amount of MgCO₃ may be weighed and added instead.

The ceramic green sheet is formed by applying the ceramic slurry onto a surface of a resin film and drying the slurry. Thereafter, the ceramic green sheet is peeled off the resin film.

Subsequently, the ceramic green sheet and the first side surface 113 of the green chip 110 are brought to face each other, pressed against each other, and stamped out together. Thus, the unfired side margin portion 41 is formed. In addition, the second side surface 114 of the green chip 110 is also brought to face the ceramic green sheet, and these constituents are pressed against each other and stamped out together. Thus, the unfired side margin portion 42 is formed. The unfired multilayer body is obtained as described above.

The unfired multilayer body obtained in accordance with the above-described example method is preferably subjected to, for example, barrel polishing and the like. The corner portions and the ridge portions of the fired multilayer body 10 will be rounded by polishing the unfired multilayer body.

The first outer electrode 51a and the second outer electrode 51b are formed at the first end surface 15 and the second end surface 16 of the multilayer body 10. The first outer electrode 51a and the second outer electrode 51b can each include the foundation electrode layer and the plated layer to be disposed on the foundation electrode layer, for example. The foundation electrode layer is formed by applying the conductive paste including the metal component and the glass component onto the end surfaces 15 and 16 of the multilayer body 10, and then baking the conductive paste. The metal component to be blended into the conductive paste can include, for example, a metal such as Cu, Ni, Ag, Pd, and Au, an alloy of Ag and Pd, and the like.

The plated layer to be disposed on the foundation electrode layer includes at least one of the metals such as, for example, Cu, Ni, Ag, Pd, and Au, the alloy of Ag and Pd, and the like. The plated layer may be the double-layered structure of the Ni-plated layer and the Sn-plated layer, for example. Nonetheless, the plated layer may include a single layer or include multiple layers.

The multilayer ceramic capacitor 1 is manufactured as described above.

In the above-described example embodiment, the multiple green chips are obtained by cutting the mother block 104 along the cutting lines X and Y, and then the unfired side margin portions are provided at both of the side surfaces of each green chip. This process may also be modified as follows.

Specifically, the mother block is cut off along the cutting lines X only, thus obtaining multiple green block bodies in a bar-like shape in which the first inner electrode layers and the second inner electrode layers are exposed to side surfaces that come into being by cutting along the cutting lines X. Then, the unfired side margin portions are formed at both of the side surfaces of each green block body. Thereafter, multiple unfired multilayer bodies are obtained by cutting the green block body along the cutting lines Y and then the unfired multilayer bodies may be fired. After firing, the multilayer ceramic capacitor can be manufactured by conducting the same procedures as those in the above-described example embodiment.

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A multilayer ceramic capacitor comprising:
a multilayer body including:
an inner layer portion defined by alternately laminating a plurality of dielectric layers and a plurality of inner electrode layers;
a pair of outer layer portions sandwiching the inner layer portion in a lamination direction; and
a pair of side margin portions sandwiching the inner layer portion and the outer layer portions in a width direction orthogonal or substantially orthogonal to the lamination direction; and
a pair of outer electrodes at both ends of the multilayer body in a length direction being orthogonal or substantially orthogonal to the lamination direction and the width direction, the outer electrodes including a first outer electrode and a second outer electrode being electrically connected to a first inner electrode layer and a second inner electrode layer of the inner electrode layers, respectively; wherein
when viewing a cross-section provided by cutting the multilayer body at a position at a central portion in the length direction and defined by the width direction and the lamination direction, a crystalline oxide including at least one of Al, Mg, and Si is present in the side margin portions as an elongate secondary phase at an aspect ratio equal to or above about 5 and equal to or below about 20.

2. The multilayer ceramic capacitor according to claim 1, wherein
about 90 atm % or more of Mg included in the crystalline oxide is made of a composite oxide including Al, Mg, and Si.

3. The multilayer ceramic capacitor according to claim 1, wherein
about 90 atm % or more of Al included in the crystalline oxide is made of a composite oxide including Al, Mg, and Si and a composite oxide including Al and Si.

4. The multilayer ceramic capacitor according to claim 1, wherein a thickness in the lamination direction of the dielectric layer sandwiched between the inner electrode layers is equal to or below about 0.45 μm.

5. The multilayer ceramic capacitor according to claim 1, wherein external dimensions of the multilayer body are set to a length equal to or below about 1.0 mm, a width equal to or below about 0.5 mm, and a height equal to or below about 0.5 mm.

6. The multilayer ceramic capacitor according to claim 1, wherein
the multilayer body has a cuboid shape or a substantially cuboid shape; and
the multilayer body includes rounded corner portions and ridge portions.

7. The multilayer ceramic capacitor according to claim 1, wherein the plurality of inner electrode layers include at least one of Ni, Cu, Ag, Pd, Ag—Pd alloy, or Au.

8. The multilayer ceramic capacitor according to claim 1, wherein the first outer electrode and the second outer electrode each include a foundation electrode layer and a plated layer on the foundation electrode layer.

9. The multilayer ceramic capacitor according to claim 8, wherein the plated layer includes at least one Cu, Ni, Ag, Pd, Au, and an alloy of Ag or Pd.
